(19) United States
(12) Patent Application Publication
(10) Pub. No.: US 2012/0265444 A1
(43) Pub. Date: Oct. 18, 2012

(54) Method for post - processing fiber optic strain measurement data

(76) Inventor: Christos Vlatas, Houston, TX (US)

(21) Appl. No.: 13/506,257

(22) Filed: Apr. 6, 2012

Related U.S. Application Data
(63) Continuation of application No. 12/460,593, filed on Jul. 22, 2009.

(51) Int. Cl. G06F 19/00

(52) U.S. Cl. 702/11

(57) ABSTRACT

A method to post process strain data records acquired by fiber optic instrumentation from Oil and Gas borehole oil well casing or similar installations is provided. A fiber optic Distributed Strain Sensing (DSS) system acquires strain records and a Distributed Temperature Sensing system (DTS) acquires temperature records along the length of the casing. The temperature records are used to derive the strain contributed by temperature which are then subtracted to obtain temperature corrected strain records. The cables are secured to the casing at each collar interval. Permanent strain variations between intervals are caused during the installation and show up as noise on the strain records. These static strain variations obscure new strain variations that are caused by structural movement that the installation is intended to measure. The temperature-corrected strain records are then processed with a digital low pass filter to expose movements in the micro-strain range.

### BACKGROUND OF THE INVENTION

Fiber optic technology made it economically possible to measure strain accurately over long distances. The technology can be used to monitor land subsidence in the Geotechnical industry and borehole events in the Oil and Gas industry. In both applications the installation involves securing the fiber optic cable to an assembly such as a borehole pipe or an oil well casing assembly at certain depth intervals. In the Oil and Gas industry the fiber optic cable is mounted on the casing with clamps at the mating collars as it is being lowered downhole into an oil well before cementing. It is difficult to maintain the same strain between the intervals. The clamps also exert a certain amount of strain on the fiber optic cable. Strain is also added to the fiber optic cable as it touches the well wall while it is being lowered downhole. These static strain variations obscure new strain changes that are caused by structural movement which the procedure is intended to measure. The static strain variations shall be referred to as static noise from here on.

The strain contribution due to temperature has to be measured and subtracted from the strain record to obtain a temperature-corrected record. The noise on the temperature-corrected record is then removed by processing each record by a digital low pass filter to reveal very small strain changes that can be easily detected and measured. The strain changes indicate movements that can then be traced to the exact locations. The method in this invention has many applications in the geotechnical and in the Oil and Gas industry to measure movements in the micro strain range. This method has shown excellent results obtained from two monitoring wells drilled around a mine in Arizona to observe land subsidence. The results are presented in the example section below.

### SUMMARY

The primary objective of the present invention is to provide a method to process structural strain measurement data records obtained by fiber optic instrumentation when acquired from Oil and Gas borehole or similar installations. The strain and temperature fiber optic cables are secured at the joining pipe collars of a pipe or an oil well casing as it being lowered downhole. The strain at each interval differs. These static strain variations show up in the data records as noise and obscure new strain changes that are caused by structural movement that the installation is intended to measure. The method in this invention shows the instrumentation to acquire the strain and temperature data, make temperature correction and filter the static noise to detect and measure structural movements in the micro-strain range.

The strain fiber optic cable is designed to be sensitive to strain but it is also sensitive to temperature. The temperature fiber optic cable is designed where the fiber is packaged loosely in the jacket to take up the slack when the cable is stretched; hence, it is not affected by strain. A DSS system is attached to the strain fiber optic cable that measures strain which contains additional strain contributed by temperature. The strain due to temperature can be measured by either of two methods.

One method is to have the temperature cable constructed with loosely packaged fiber and use a DTS instrument that employs the Raman method to measure temperature. The strain/temperature coefficient (micro strains per degrees ° C.) of the strain fiber optic cable can be measured in a laboratory environment. Each temperature measurement is multiplied by the strain/temperature coefficient to obtain a strain correction due to temperature. The strain contributed by temperature is then subtracted from the DSS strain measurement to obtain a temperature-corrected strain measurement.

A second method is to have the temperature fiber optic cable fabricated with the same type of fiber used to measure strain. The fiber is again constructed again with loosely packaged fiber. The strain due to temperature is measured by the same BOTDR instrument and it is subtracted from the measurement obtain from the strain fiber optic cable to obtain a temperature-corrected strain measurement on the fiber optic cable.

The temperature-corrected strain record is then processed by a software digital low pass filter to remove static a noise. The method in this invention shows how to apply the settings on the digital low pass filter, to obtain a clear indication of structural changes from a temperature-corrected strain record. When a new processed strain record is compared with a previously processed record the location of very small deformations, that indicate movement, can be measured in the micro strain range.

### BRIEF DESCRIPTION OF DRAWINGS

FIG. 1 is diagram illustrating an embodiment of hardware instrumentation setup.

FIG. 2 is diagram illustrating an embodiment of geotechnical observation well hardware setup.

FIG. 3 is diagram illustrating an embodiment of geotechnical observation well temperature data record.

FIG. 4 is diagram illustrating an embodiment of unfiltered temperature-corrected strain data records.

FIG. 5 is a diagram illustrating an embodiment of a filtered temperature-corrected strain data records with sampling frequency 0.5 Hz, cutoff frequency 0.005 Hz and filter order 5.

FIG. 6 is a diagram illustrating an embodiment of a filtered temperature-corrected strain data with sampling frequency 0.5 Hz, cutoff frequency 0.0025 Hz and filter order 5.

FIG. 7 is a diagram illustrating an embodiment of a filtered temperature-corrected strain data with sampling frequency 100 Hz, cutoff frequency 1.0 Hz and filter order 5.

FIG. 8 is a diagram illustrating an embodiment of a filtered temperature-corrected strain data with sampling frequency 100 Hz, cutoff frequency 0.5 Hz and filter order 5.

FIG. 9 is a diagram illustrating an embodiment of a filtered temperature-corrected strain data with sampling frequency 100 Hz, cutoff frequency 0.5 Hz and filter order 1.

### DETAILED DESCRIPTION OF THE PREFERRED EMBODIMENT

The method in this invention is to acquire strain and temperature data from fiber optic cables, subtract strain contribution due to temperature and apply a low pass filter to the temperature-corrected strain data to remove static noise which obscures small strain changes due to movement that the installation is intended to measure. Static noise is produced during the installation and it is due to variation of strain between the interval points where the strain fiber optic cable is secured to a borehole pipe or an oil well casing.

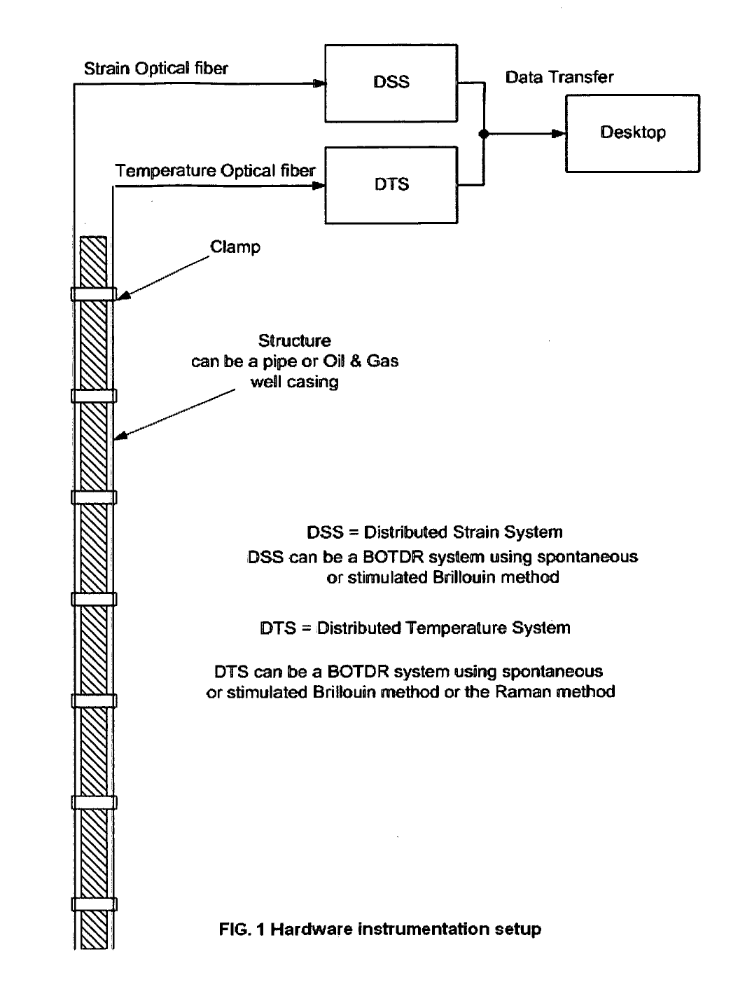

The drawings are provided for illustration and not for the purpose to limit the invention as mentioned in the claims. A block diagram illustrating a configuration of the fiber optic cables and the instrumentation is shown in FIG. 1. A fiber optic cable to measure strain is clamped on the structure along with a second cable to measure temperature. A structure is an assembly such as a pipe that can be inserted in the area of interest such as a drilled hole in a tunnel which is mostly used in the geotechnical industry or a borehole oil well casing used in the Oil and Gas industry. The strain fiber optic cable is connected to the DSS instrument and the temperature fiber optic cable is connected to the DTS instrument. The DSS strain records and the DTS temperature records are transferred to a Desktop computer where they are processed to produce temperature-corrected filtered records that identify deformations due to movements in the micro-strain range.

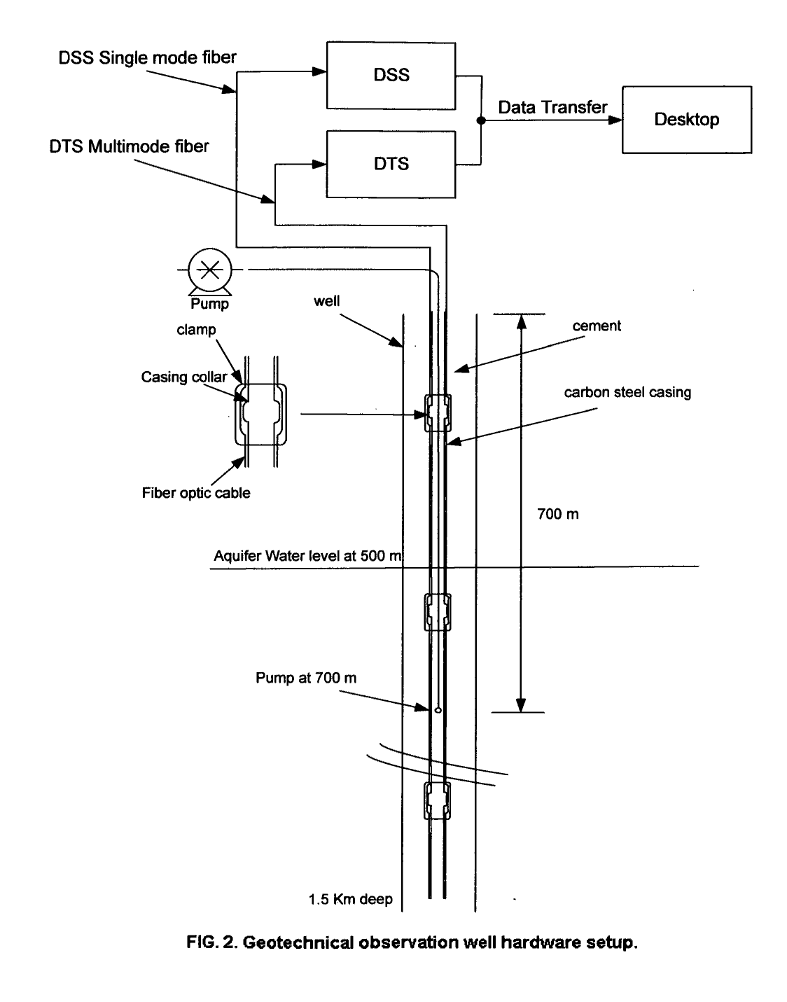

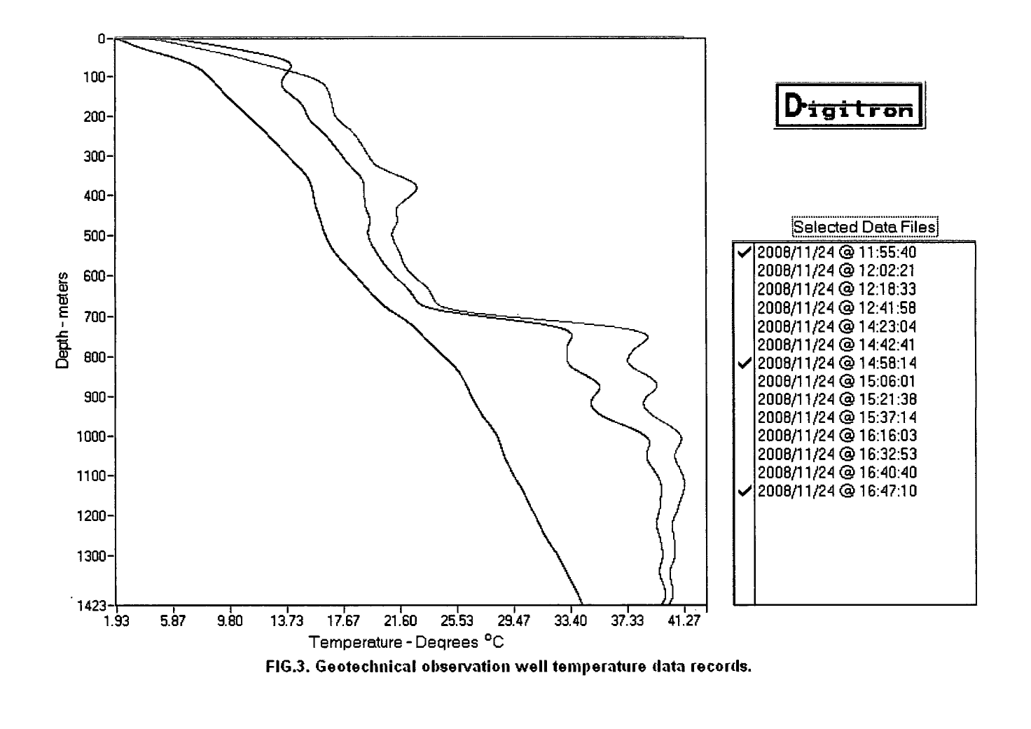

In installations where the structure is buried, it is difficult to keep the strain at each interval constant as it is being lowered downhole. In addition the fiber optic cables may touch the wall of the well and make interval strain variations even worse. These strain variations show up as noise on the strain data records and obscure any future small strain changes that occur due to structural movements. After the installation the cable is inaccessible to make any interval strain adjustments to reduce the noise. This is particularly important in the Oil and Gas borehole installations where the fiber optic cable is being attached to the casing at the collar locations with as it is being lowered downhole, shown in FIG. 2. The clamps are designed to protect the cables at the pipe mating collars and at the same time secure the fiber optic cables to the casing. The clamps are mentioned as an illustration and not intended to limit the claims in this invention. FIG. 3 shows an unfiltered strain data record of the well casing to monitor land subsidence near a copper mine in Arizona. Field data obtained from the Arizona site are shown and discussed in the example section below.

Two fiber optic cables are mounted on the casing. One fiber optic cable is used to measure strain and a second fiber optic cable is used to measure strain contributed by temperature. The strain fiber optic cable is sensitive to both strain and temperature. The temperature fiber optic cable is sensitive only to temperature. This is accomplished by constructing the temperature cable with a certain percent of loose fiber in the jacket. When the jacket stretches the fiber inside the jacket takes up the slack and the fiber does not experience any strain. The strain due to temperature is measured and subtracted from the DSS strain measurement records to obtain the net strain applied on the structure. Various manufacturers provide numerous cable designs to withstand a harsh environment.

The DSS system can be a BOTDR employing the stimulated Brillouin method or the spontaneous Brillouin method is used to measure strain from the strain fiber optic cable. However, the strain contributed by temperature has to be measured and subtracted from strain measurement obtained from the strain fiber optic cable. The strain contributed by temperature can be performed by either of two methods.

The first method uses a DTS system that employs the Raman method to measure temperature. The temperature fiber optic cable contains a loosely packaged fiber except it need not be the same type of fiber as the one used for strain measurement. However, this method requires that the strain/temperature coefficient of the strain fiber be known. The strain temperature coefficient can be measured in a laboratory environment. A section of the strain fiber optic cable is placed in an oven in a relaxed condition (not experiencing strain). The strain measurement is recorded at temperature intervals within the temperature range of interest. The coefficient is determined from the strain/temperature slope by applying a linear fit curve on the measured values. Each reading on the temperature record is then multiplied by the strain/temperature coefficient to obtain the strain contributed by temperature. The calculated strain due to temperature is then subtracted from the DSS strain records to obtain the temperature-corrected strain on the structure.

The second method uses a fiber optic cable with the same type of fiber used in the strain fiber optic cable except it is loosely packaged in its jacket and does not experience any strain. The same DSS system that is used to measure strain from the strain fiber optic cable to also used to measure strain contributed by temperature from the temperature fiber optic cable. The measurement obtained from the temperature fiber optic cable can then be directly subtracted from the measurement obtained form the strain fiber optic cable to derive the temperature-corrected strain applied on the structure.

The difference between the spontaneous vs. the stimulated Brillouin method is that the spontaneous method only requires as single fiber optic cable whereas the stimulated method requires a loop configuration but has a better dynamic range. The choice is instrumentation is up to the user's discretion and is not intended to limit the claims of this invention. Similarly, the temperature measurement can be performed with a BOTDR instrumentation employing either spontaneous or stimulated Brillouin method or instrumentation employing the Raman method.

A low pass filter is used to filter the static noise from the temperature-corrected strain data record. Any type of low pass filter can be used, however, a Butterworth low pass digital filter along with filter parameter settings are selected as an illustration but not limit the claims of this invention. There are three filter parameter settings that need to be populated to give good results. These include the sample frequency, the cutoff frequency and the filter order.

The spatial resolution of the BOTDR can be used to select the sample frequency. This is the distance interval that a strain measurement is acquired by the instrument. It can be every 0.5 meters or any multiple depending on the spatial resolution selected on the BOTDR instrument. In the example below the spatial resolution of the BOTDR was 0.5 meters; hence the sample frequency was chosen to be 0.5 Hz. The cutoff frequency has to be at least half of the sampling frequency to abide by Nyquist law (or the sampling frequency has to be at least twice the cutoff frequency). The cutoff frequency, however, can be any fraction less than one half the sampling frequency. The filter order can be any number greater than 1 bearing in mind that high numbers affect the phase significantly. The setting selections are mentioned in this section but they are applied on actual field data and the results are shown graphically in the example section below.

The cutoff frequency can be any fraction of the sampling frequency. It can be 1/50^{th} or 1/100^{th} of the sampling frequency. In this illustration it was chosen as 0.5/100=0.005 Hz. The response can be improved further by reducing the cutoff frequency by ½ (0.005/2=0.0025 Hz) and so on. The cutoff frequency can then be fine tuned by 0.001 Hz up or down to obtain the preferred response. These are details that are dependent on the preference of the user and the quality of the data. The filter order can be changed from 1 to 5 without affecting the phase significantly.

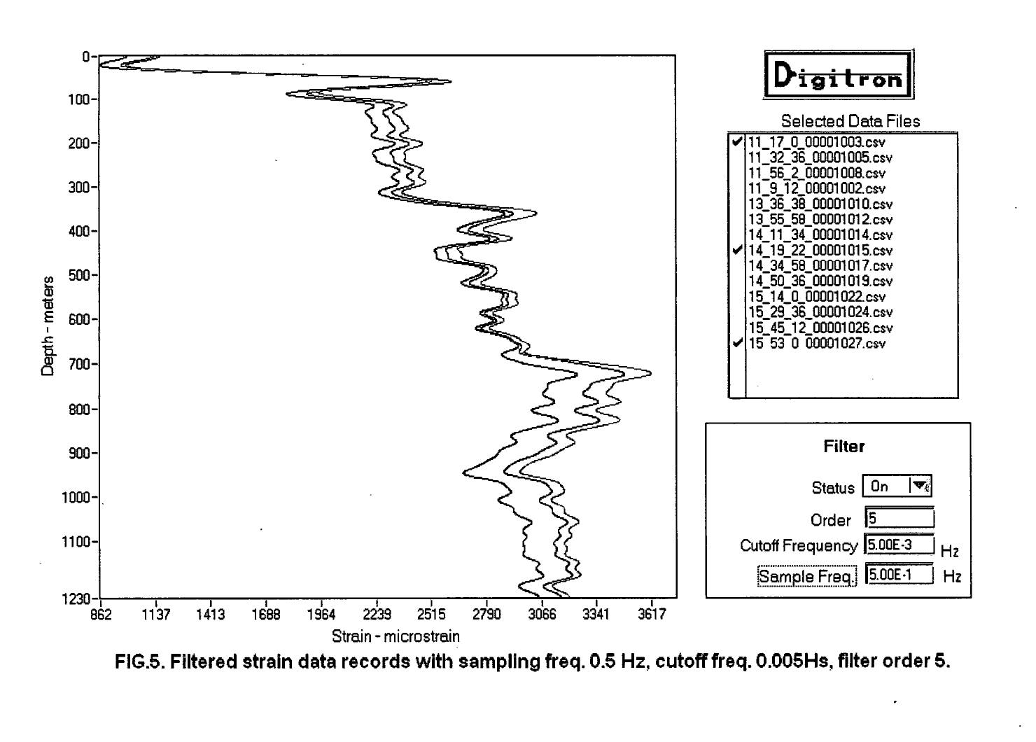

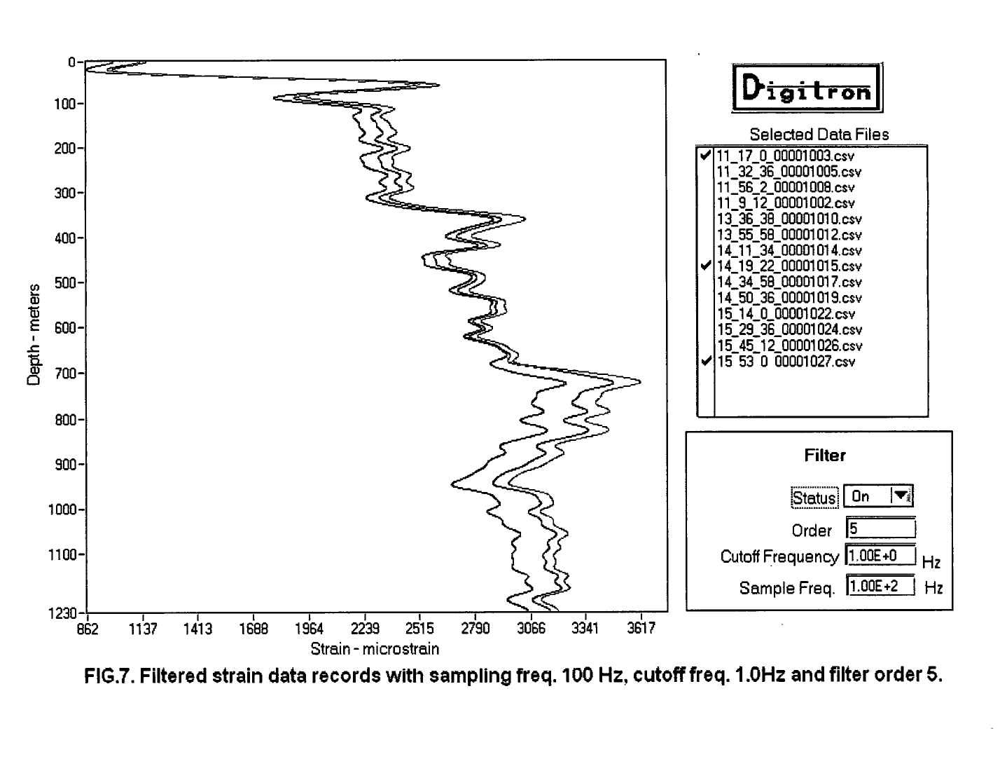

The initial sampling frequency in this example was chosen to be 0.5 Hz and the cutoff frequency 1/100^{th} the sampling frequency 0.5/100=0.005 Hz as shown in FIG. 5. However, the sampling frequency can be chosen arbitrarily. As an illustration, a sampling frequency of 100 Hz and a cutoff of 1/100^{th} of the sampling frequency 100/100=1 Hz shown in FIG. 7, gives the same results as the choice of sampling frequency of 0.5 Hz and cutoff frequency of 0.005 Hz. It is the ratio of the sampling frequency to the cutoff frequency that gives the best filtered response. Once the digital low pass filter settings are established it is important to process all past and future data records by the same settings to all the temperature-corrected records. When the records are plotted on the same graph, very small strain changes can be easily observed and measured.

### Example

Data obtained from a Geotechnical observation well is submitted as an example to illustrate and not limit the invention. The hardware setup is shown in FIG. 2. A Geotechnical observation well is drilled 1.5 Km deep in the vicinity of a mine to monitor land subsidence. A carbon steel casing normally used in the Oil and Gas industry is installed in the well. Fiber optic cables are attached at the outer wall of the casing as it is being lowered in the well. A clamp secures and protects the cable at each casing collar as shown in FIG. 2. The well is cemented and the fiber is routed to the instrumentation to measure strain and temperature

The well contained water from an aquifer at depths below 500 meters. The water was pumped out at a depth of 600 meters to test purity of the water. The temperature of the water at that depth was 40 C and got hotter with depth. The temperature of the casing below 600 meters increased as the hotter water was being pumped out to the surface as shown FIG. 2. This gave an excellent opportunity to test the integrity of the measurement by introducing dynamic changes to the structure. The well temperature profile is shown in FIG. 3. The Y-axis is depth and the X-axis is strain.

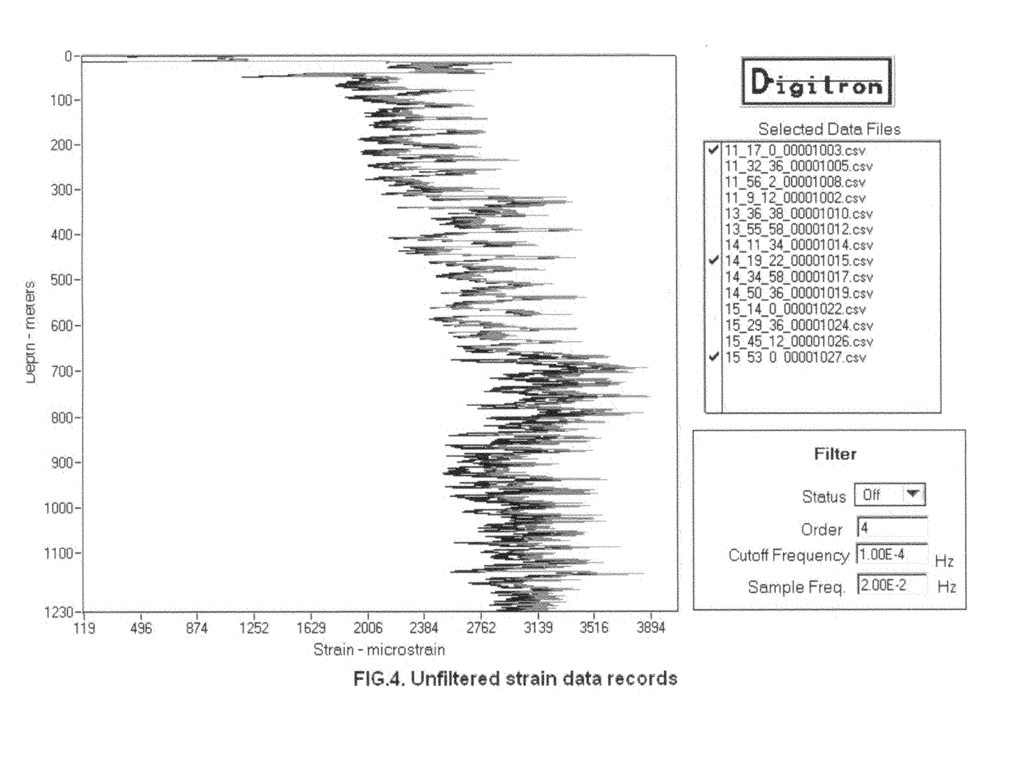

The increase in temperature caused structural changes to take place. This example serves the purpose to illustrate small structural changes caused by the gradual increase of temperature caused by the hotter water coming from lower depths. The unfiltered temperature-corrected strain data records obtained at different temperatures are shown in FIG. 4 and it is difficult to observe any changes on the graph. However, there were changes in the strain response of the fiber partially due to the temperature increase and partially due to the structural deformation of the casing.

Strain records and temperature records were being acquired concurrently. The temperature records were acquired by a DTS 5100 Fiber Optic Distributed Temperature Sensing (DTS) instrument manufactured by Sensortran and are shown in FIG. 3. Each reading on the temperature records was multiplied by the strain/temperature coefficient to find the strain contributed by temperature which was then subtracted from the strain records to a obtain temperature-corrected strain records.

The strain data records were acquired by an AQ8603 BOTDR manufactured by Yokogawa. The data records were processed with a software application written in C that used a software Butterworth low pass digital filter. The sample rate, cutoff frequency and filter order settings were chosen using the method in this invention.

The function call used in this example is:

Bw_{—}LPF(x[], n, sf, cf, order, y[]);

Where:
x[]=input array (double).
n=number of elements in the array (integer),
sf=sampling frequency (double),
cf=cutoff frequency (double),
or=order (integer),
y[]=output array (double).

FIG. 5 is a diagram illustrating an embodiment of a filtered temperature-corrected strain data record with sampling frequency 0.5 Hz, cutoff frequency 0.005 Hz and filter order 5.

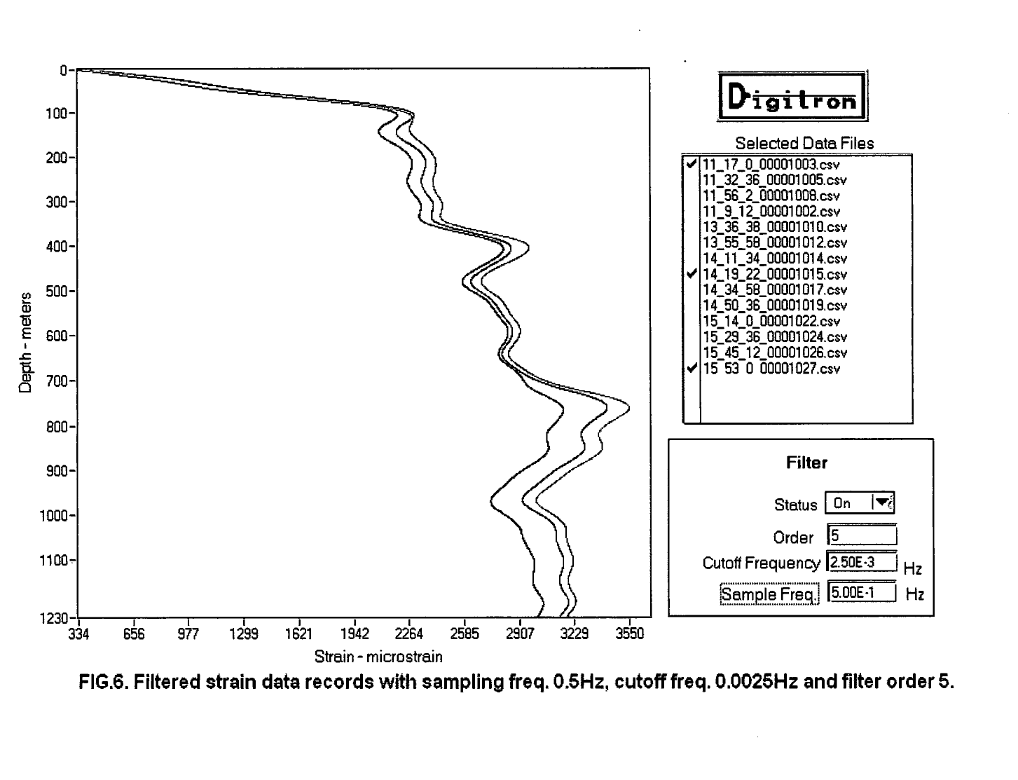

The graph in FIG. 5 shows filtered temperature-corrected processed data after applying a low pass filter with sampling frequency 0.5 Hz, cutoff frequency 0.005 Hz and filter order 5. The change in strain due to temperature can be clearly seen in detail. An improved response, shown in FIG. 6, is obtained when the cutoff frequency is lowered by a factor of 2 to 0.0025 Hz.

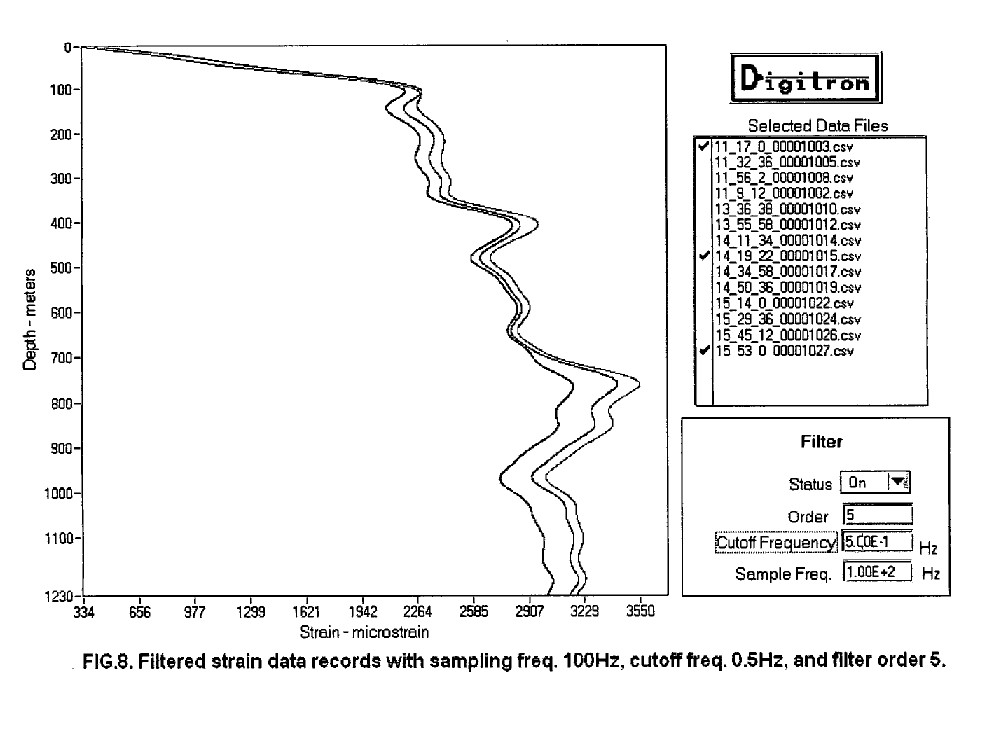

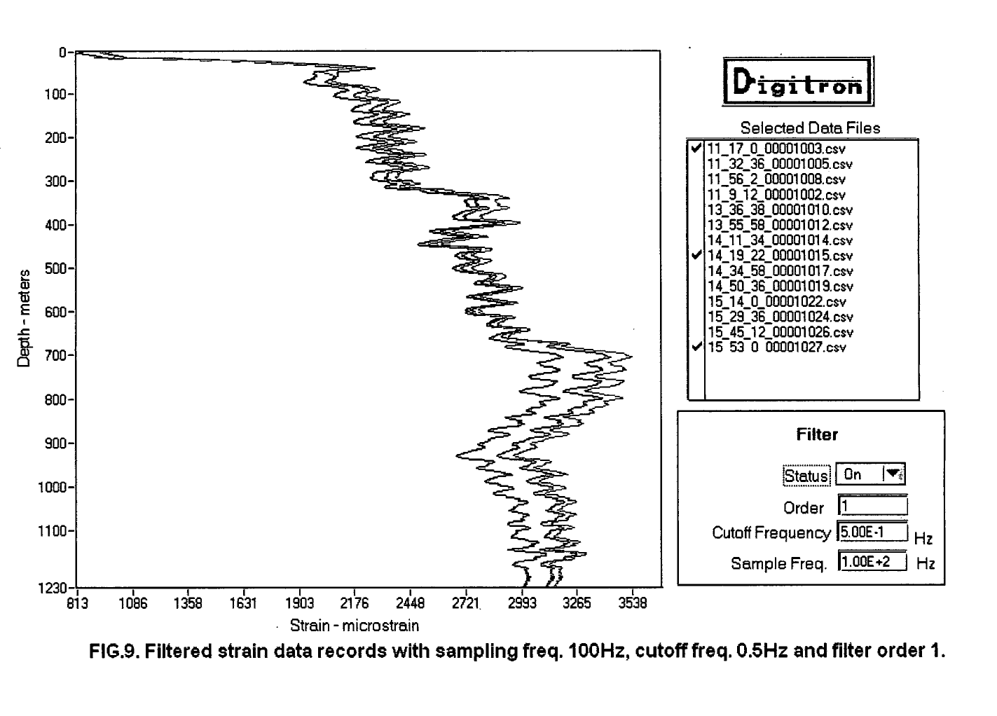

The response of a sampling frequency of 100 and a cutoff at 1 Hz and filter order 5 is shown in FIG. 7. There is no difference between the response at 0.5 Hz sampling frequency and 0.005 Hz cutoff frequency and the response at 100 Hz sampling frequency and 1 Hz cutoff frequency since the ratio of sample frequency to cutoff frequency of 100 is the same for both selections. Again an improved response is obtained by reducing the cutoff frequency by a factor of 2 to 0.5 Hz shown in FIG. 8. The filter order can be in the range between 1 and 5. FIG. 9 shows the response at sample frequency 100 Hz, cutoff frequency 0.5 Hz and filter order 1. The only parameter changed between FIG. 8 and FIG. 9 is the filter order which was changed from 5 to 1. At higher filter orders the phase change is significant. The test showed a maximum net deformation change of 50 micro-strains due to structural movement.

1. A method to post process a fiber optic structural strain data record with a digital low pass filter after it has been acquired by a BOTDR instrument from a fiber optic cable attached to a borehole structure, that can be a pipe or an oil well casing assembly, that has been temperature corrected by a data record acquired by either a Raman based instrument or a BOTDR instrument employing either spontaneous or stimulated Brillouin scattering method consisting the following steps;
Secure rugged strain fiber optic cable along the length of a pipe or oil well casing in the region of interest;
Secure rugged temperature fiber optic cable along the same pipe or oil well casing in the region of interest.
Acquire fiber optic strain data records from the strain fiber optic cable;
Acquire fiber optic temperature data records from the temperature fiber optic cable;
Determine strain measurement contributed by temperature;
Subtract strain due to temperature from the strain data record to obtain a temperature-corrected accurate strain record;
Use a computer application to read the strain and temperature data records, calculate the strain due to temperature and obtain a temperature-corrected strain records.
Process the temperature-corrected strain data records with a software digital low pass filter;

2. A method to claim 1 further comprises of strain data obtained from a DSS system with a BOTDR instrument using spontaneous Brillouin scattering method.

3. A method to claim 1 further comprises of strain data obtained from a DSS system with a BOTDR instrument using stimulated Brillouin scattering method.

4. A method to claim 1 further comprises of temperature data obtained from a BOTDR instrument using the Brillouin spontaneous method;

5. A method to claim 1 further comprises of temperature data obtained from a BOTDR instrument using the stimulated Brillouin method;

6. A method to claim 1 further comprises of temperature data obtained from a fiber optic instrument using the RAMAN method

7. A method to claim 1 further comprises to post process fiber optic strain data records by subtracting strain contributed by temperature.

8. A method to claim 1 further comprises a software application to read strain and temperature data records from the strain and temperature instrumentation and perform the temperature correction.

9. A method to claim 1 further comprises to post process fiber optic temperature-corrected strain data by a software digital low pass filter.
